(19) United States
(12) Patent Application Publication
(10) Pub. No.: US 2023/0032997 A1
(43) Pub. Date: Feb. 2, 2023

(54) MOBILE DEVICE AND CONTROL METHOD FOR AVOIDING ACCIDENTAL SHUTDOWN

(71) Applicant: Acer Incorporated, New Taipei City (TW)

(72) Inventors: Shuo-Jung CHOU, New Taipei City (TW); Chuan-Jung WANG, New Taipei City (TW); Chih-Chiang CHEN, New Taipei City (TW)

(21) Appl. No.: 17/464,963

(22) Filed: Sep. 2, 2021

(30) Foreign Application Priority Data
Jul. 26, 2021 (TW) 110127337

(51) Int. Cl. H02J 7/00

(52) U.S. Cl. CPC H02J 7/00306; H02J 7/005

(57) ABSTRACT

A mobile device for avoiding accidental shutdown includes a battery cell, a controller, and a jack element. The controller defines a first delay time and a second delay time. The first delay time is relative to the ODCP (Over Discharge Current Protection) of the battery cell. The second delay time is relative to the OVP (Over Voltage Protection) of the battery cell. When a plug of a power supply device is unplugged from the jack element, the controller detects an SOH (State of Health) of the battery cell. The controller compares the SOH with a first threshold ratio and a second threshold ratio. Then, the controller extends the first delay time and the second delay time according to a first multiplier, a second multiplier, or a third multiplier.

### CROSS REFERENCE TO RELATED APPLICATIONS

This Application claims priority of Taiwan Patent Application No. 110127337 filed on Jul. 26, 2021, the entirety of which is incorporated by reference herein.

### BACKGROUND OF THE INVENTION

### Field of the Invention

The disclosure generally relates to a mobile device, and more specifically, to a mobile device for avoiding accidental shutdowns.

### Description of the Related Art

Notebook and tablet computers usually require battery components. However, after a long period of use, a battery will gradually age, and the computer device may shut down unexpectedly. Accordingly, there is a need to propose a novel solution for solving the problems of the prior art.

### BRIEF SUMMARY OF THE INVENTION

In an exemplary embodiment, the invention is directed to a mobile device for avoiding accidental shutdown. The mobile device is selectively coupled to a power supply device. The mobile device includes a battery cell, a controller, and a jack element. The controller defines a first delay time and a second delay time. The first delay time is relative to the ODCP (Over Discharge Current Protection) of the battery cell. The second delay time is relative to the OVP (Over Voltage Protection) of the battery cell. The jack element includes a detection pin. When a plug of the power supply device is unplugged from the jack element, the detection pin notifies the controller, such that the controller detects an SOH (State of Health) of the battery cell. If the SOH is better than a first threshold ratio, the controller will extend the first delay time and the second delay time according to a first multiplier. If the SOH is between the first threshold ratio and a second threshold ratio, the controller will extend the first delay time and the second delay time according to a second multiplier. If the SOH is worse than the second threshold ratio, the controller will extend the first delay time and the second delay time according to a third multiplier.

In some embodiments, the controller is implemented with a gauge IC (Integrated Circuit), an EC (Embedded Controller), or a combination thereof.

In some embodiments, in response to the extension of the first delay time and the second delay time, the controller starts to count a predetermined time.

In some embodiments, after the predetermined time expires, the controller restores the first delay time and the second delay time to their unextended states.

In some embodiments, the first threshold ratio is equal to 70%.

In some embodiments, the second threshold ratio is equal to 30%.

In some embodiments, the first multiplier is equal to 2.

In some embodiments, the second multiplier is equal to 3.

In some embodiments, the third multiplier is equal to 4.

In another exemplary embodiment, the invention is directed to a control method for avoiding accidental shutdown. The control method includes the steps of: providing a battery cell, a controller, and a jack element; defining a first delay time and a second delay time via the controller, wherein the first delay time is relative to ODCP (Over Discharge Current Protection) of the battery cell, and the second delay time is relative to OVP (Over Voltage Protection) of the battery cell; when a plug of the power supply device is unplugged from the jack element, detecting an SOH (State of Health) of the battery cell via the controller; if the SOH is better than a first threshold ratio, extending the first delay time and the second delay time via the controller according to a first multiplier; if the SOH is between the first threshold ratio and a second threshold ratio, extending the first delay time and the second delay time via the controller according to a second multiplier; and if the SOH is worse than the second threshold ratio, extending the first delay time and the second delay time via the controller according to a third multiplier.

### BRIEF DESCRIPTION OF DRAWINGS

The invention can be more fully understood by reading the subsequent detailed description and examples with references made to the accompanying drawings, wherein:

FIG. 1 is a diagram of a mobile device and a power supply device according to an embodiment of the invention;

FIG. 2 is a diagram of ODCP (Over Discharge Current Protection) of a battery cell according to an embodiment of the invention;

FIG. 3 is a diagram of OVP (Over Voltage Protection) of a battery cell according to an embodiment of the invention;

FIG. 4 is a diagram of a mobile device coupled to a power supply device according to an embodiment of the invention;

FIG. 5 is a diagram of a mobile device decoupled from a power supply device according to an embodiment of the invention; and

FIG. 6 is a flowchart of a control method for avoiding accidental shutdown according to an embodiment of the invention.

### DETAILED DESCRIPTION OF THE INVENTION

In order to illustrate the purposes, features and advantages of the invention, the embodiments and figures of the invention are described in detail below.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

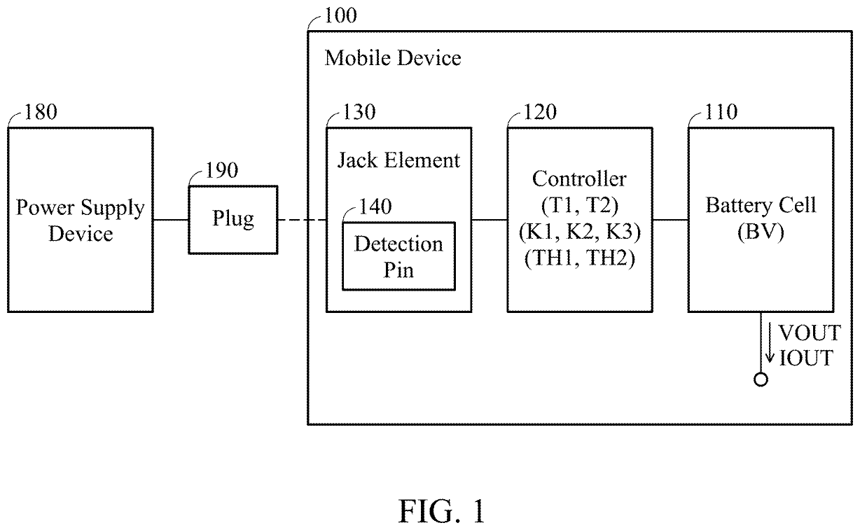

FIG. 1 is a diagram of a mobile device 100 and a power supply device 180 according to an embodiment of the invention. For example, the mobile device 100 may be a smart phone, a tablet computer, or a notebook computer. As shown in FIG. 1, the mobile device 100 includes a battery cell 110, a controller 120, and a jack element 130. The jack element 130 includes a detection pin 140. On the other hand, the power supply device 180 has a plug 190, and it is not a portion of the mobile device 100. It should be noted that the electronic device 100 may further include other components, such as a processor, a speaker, a touch control module, and/or a housing, although they are not displayed in FIG. 1.

The battery cell 110 can provide electric power for the mobile device 100. For example, during a discharge process, the battery cell 110 may generate an output voltage VOUT and an output current IOUT, such that any electronic component (not shown) in the mobile device 100 can be supplied by the output voltage VOUT and the output current IOUT.

The controller 120 can continuously monitor the output and the operation state of the battery cell 110. In some embodiments, the controller 120 is implemented with a gauge IC (Integrated Circuit), an EC (Embedded Controller), or a combination thereof. The controller 120 can define a first delay time T1 and a second delay time T2. The first delay time T1 is relative to the ODCP (Over Discharge Current Protection) of the battery cell 110. The second delay time T2 is relative to the OVP (Over Voltage Protection) of the battery cell 110.

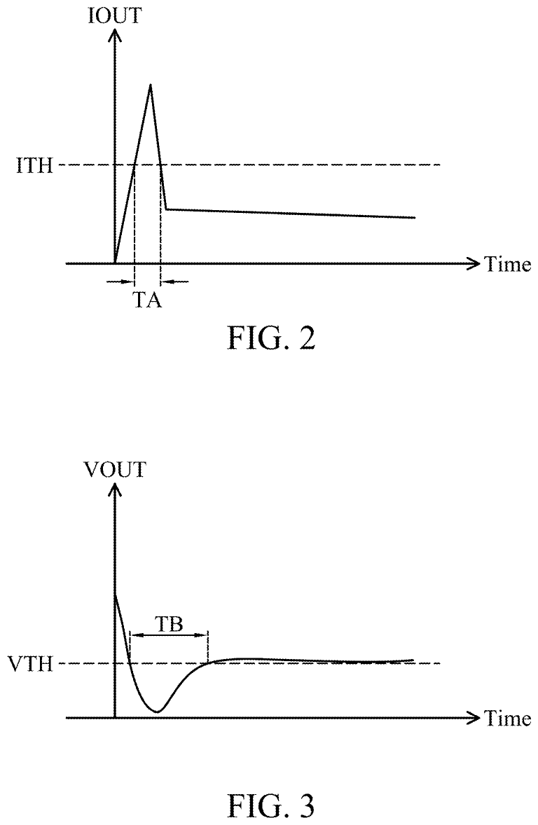

FIG. 2 is a diagram of the ODCP of the battery cell 110 according to an embodiment of the invention. During the discharge process of the battery cell 110, the output current IOUT of the battery cell 110 may be greater than or equal to a current threshold value ITH and may be maintained for a time period TA. If the controller 120 detects that the time period TA is longer than the first delay time T1, it will trigger the mechanism of ODCP, and therefore the controller 120 will immediately stop any output of the battery cell 110 (i.e., both the output voltage VOUT and the output current IOUT will quickly drop to 0).

FIG. 3 is a diagram of the OVP of the battery cell 110 according to an embodiment of the invention. During the discharge process of the battery cell 110, the output current VOUT of the battery cell 110 may be lower than or equal to a voltage threshold value VTH and may be maintained for a time period TB. If the controller 120 detects that the time period TB is longer than the second delay time T2, it will trigger the mechanism of OVP, and therefore the controller 120 will immediately stop any output of the battery cell 110 (i.e., both the output voltage VOUT and the output current IOUT will quickly drop to 0).

According to the embodiments of FIG. 2 and FIG. 3, the mechanisms of ODCP and OVP can reduce the probability of the batter cell 110 being damaged. By changing the first delay time T1 and the second delay time T2, the controller 120 can adjust the trigger threshold of each of the ODCP and OVP according to different requirements.

The mobile device 100 is selectively coupled to the power supply device 180. When the mobile device 100 is coupled to the power supply device 180, the power supply device 180 can provide stable electric power of an AC (Alternating Current) power source (not shown) for the mobile device 100, and the battery cell 110 can enter a charge process.

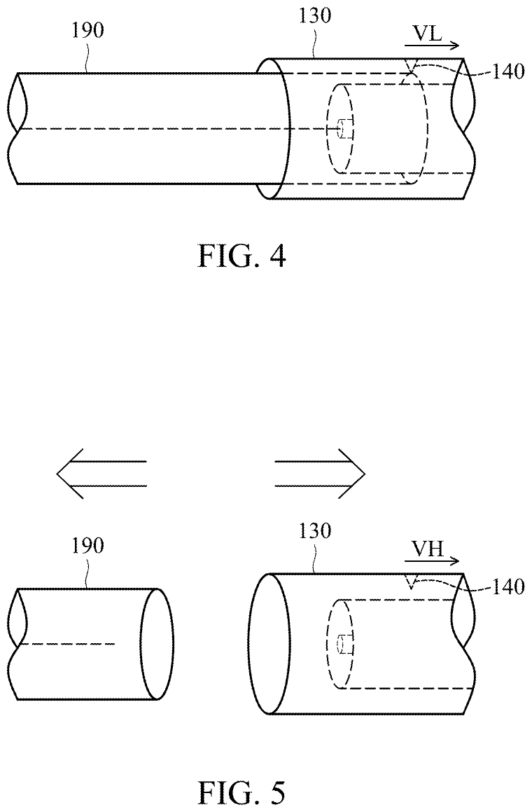

FIG. 4 is a diagram of the mobile device 100 coupled to the power supply device 100 according to an embodiment of the invention. In the embodiment of FIG. 4, the plug 190 of the power supply device 180 is inserted in the jack element 130 of the mobile device 100. At this time, the plug 190 of the power supply device 180 touches the detection pin 140 of the jack element 130, such that the detection pin 140 generates a low-logic voltage VL.

FIG. 5 is a diagram of the mobile device 100 decoupled from the power supply device 100 according to an embodiment of the invention. In the embodiment of FIG. 5, the plug 190 of the power supply device 180 is unplugged from the jack element 130 of the mobile device 100. At this time, the plug 190 of the power supply device 180 does not touch the detection pin 140 of the jack element 130, such that the detection pin 140 generates a high-logic voltage VH.

The controller 120 is coupled between the battery cell 110 and the jack element 130. By analyzing the voltage at the detection pin 140, the controller 120 can easily check whether the plug 190 of the power supply device 180 is inserted in the jack element 130 of the mobile device 100. For example, if the voltage at the detection pin 140 is switched from low-logic voltage VL to the high-logic level VH, the controller 120 can determine that the plug 190 of the power supply device 180 is just unplugged from the jack element 130 of the mobile device 100.

When the plug 190 of the power supply device 180 is unplugged from the jack element 130 of the mobile device 100, the controller 120 can detect the SOH BV of the battery cell 110. In some embodiments, the SOH BV of the battery cell 110 is defined according to the following equation (1):

$$B V = \frac{F C C}{D C} \qquad ( 1 )$$

where “BV” represents the SOH BV of the battery cell 110, “FCC” represents the fully charged capacity of the battery cell 110, and “DC” represents the design capacity of the battery cell 110.

It should be understood that since the fully charged capacity of the battery cell 110 is lower than or equal to the design capacity of the battery cell 110, the SOH BV of the battery cell 110 may be from 0 to 1 (or from 0% to 100%). Next, the controller 120 can compare the SOH BV of the battery cell 110 with a first threshold ratio TH1 and a second threshold ratio TH2, and then perform the corresponding operations. For example, the first threshold ratio TH1 may be greater than 50%, and the second threshold ratio TH2 may be less than 50%, but they are not limited thereto. In alternative embodiments, the controller 120 may compare the SOH BV of the battery cell 110 with more threshold ratios, so as to perform more different operations.

If the SOH BV of the battery cell 110 is better than the first threshold ratio TH1 (e.g., BV≥TH1), the controller 120 will extend the first delay time T1 and the second delay time T2 according to the first multiplier K1, and it will be described as the following equations (2) and (3):

T1D=T1·K1 (2)

T2D=T2·K1 (3)

where “T1D” represents the extended first delay time T1, “T2D” represents the extended second delay time T2, “T1” represents the original first delay time T1, “T2” represents the original second delay time T2, and “K1” represents the first multiplier K1.

If the SOH BV of the battery cell 110 is between the first threshold ratio TH1 and the second threshold ratio TH2 (e.g., TH1>BV≥TH2), the controller 120 will extend the first delay time T1 and the second delay time T2 according to a second multiplier K2, and it will be described as the following equations (4) and (5):

T1D=T1·K2 (4)

T2D=T2·K2 (5)

where “T1D” represents the extended first delay time T1, “T2D” represents the extended second delay time T2, “T1” represents the original first delay time T1, “T2” represents the original second delay time T2, and “K2” represents the second multiplier K2.

If the SOH BV of the battery cell 110 is worse than the second threshold ratio TH2 (e.g., BV<TH2), the controller 120 will extend the first delay time T1 and the second delay time T2 according to a third multiplier K3, and it will be described as the following equations (6) and (7):

T1D=T1·K3 (6)

T2D=T2·K3 (7)

where “T1D” represents the extended first delay time T1, “T2D” represents the extended second delay time T2, “T1” represents the original first delay time T1, “T2” represents the original second delay time T2, and “K3” represents the third multiplier K3.

To be brief, if the SOH BV of the battery cell 110 is gradually degraded, the controller 120 can extend the first delay time T1 of ODCP and the second delay time T2 of OVP correspondingly. During the discharge process, since the thresholds of ODCP and OVP can be dynamically adjusted, the probability of the mobile device 100 being accidentally shut down, caused by the suddenly-stopping output of the battery cell 110, is effectively reduced. With the design of the invention, the operational stability of the mobile device 100 is significantly improved.

In some embodiments, the element parameters of the mobile device 100 will be described as follows. The current threshold value ITH may be about 5 A. The voltage threshold value VTH may be about 2.8V. The first threshold ratio TH1 may be about 70%. The second threshold ratio TH2 may be about 30%. The first multiplier K1, the second multiplier K2, and the third multiplier K3 may be greater than or equal to 2. The third multiplier K3 may be greater than the second multiplier K2. The second multiplier K2 may be greater than the first multiplier K1. For example, the first multiplier K1 may be 2, the second multiplier K2 may be 3, and the third multiplier K3 may be 4. The above ranges of element parameters are calculated and obtained according to many experimental results, and they help to optimize the operational stability of the mobile device 100.

For example, the first delay time T1 and the second delay time T2 may be determined according to the following Table I, but they are not limited thereto.

TABLE I
Exemplary Adjustments of First Delay
Time and Second Delay Time

| | | Extended | Extended | Extended |
|---|---|---|---|---|
| | | State | State | State |
| | Original | According | According | According |
| | State | to First | to Second | to Third |
| | (Unextended | Multi- | Multi- | Multi- |
| | State) | plier K1 | plier K2 | plier K3 |
| First Delay | 5 seconds | 10 seconds | 15 seconds | 20 seconds |
| Time T1 | | | | |
| Second Delay | 4 seconds | 8 seconds | 12 seconds | 16 seconds |
| Time T2 | | | | |

In alternative embodiments, in response to the extension of the first delay time T1 and the second delay time T2, the controller 120 can start to count a predetermined time (e.g., 20 seconds). For example, when the plug 190 of the power supply device 180 is unplugged from the jack element 130 of the mobile device 100 (or when the voltage at the detection pin 140 is switched from the low-logic voltage VL to the high-logic voltage VH), the controller 120 can start to count the predetermined time, but it is not limited thereto. Next, after the predetermined time expires, the controller 120 can restore the first delay time T1 and the second delay time T2 to their unextended states. In other words, the first delay time T1 and the second delay time T2 are temporarily extended. Such a design can protect the battery cell 110 from being damaged.

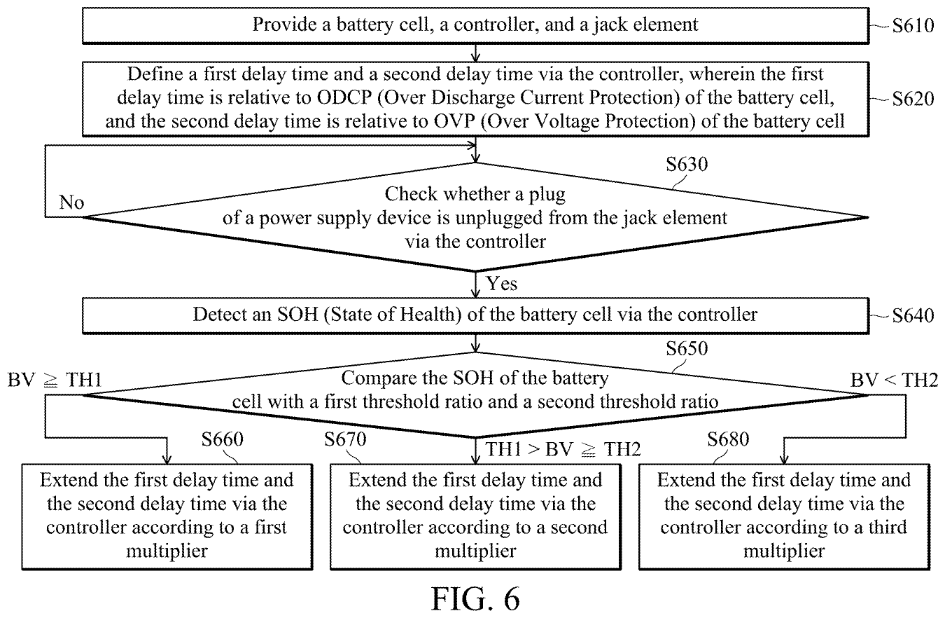

FIG. 6 is a flowchart of a control method for avoiding accidental shutdown according to an embodiment of the invention. The aforementioned control method includes the following steps. In step S610, a battery cell, a controller, and a jack element are provided. In step S620, a first delay time and a second delay time are defined by the controller. The first delay time is relative to ODCP (Over Discharge Current Protection) of the battery cell. The second delay time is relative to OVP (Over Voltage Protection) of the battery cell. In step S630, whether a plug of a power supply device is unplugged from the jack element is checked by the controller. If so, in step S640, an SOH (State of Health) of the battery cell is detected by the controller. In step S650, the SOH of the battery cell is compared with a first threshold ratio and a second threshold ratio. If the SOH is better than a first threshold ratio, in step S660, the first delay time and the second delay time will be extended by the controller according to a first multiplier. If the SOH is between the first threshold ratio and the second threshold ratio, in step S670, the first delay time and the second delay time will be extended by the controller according to a second multiplier. If the SOH is worse than the second threshold ratio, in step S680, the first delay time and the second delay time will be extended by the controller according to a third multiplier. It should be understood that the above steps are not required to be performed in order, and every feature of the embodiments of FIGS. 1 to 5 may be applied to the control method of FIG. 6.

The invention proposes a novel mobile device. In comparison to the conventional design, the invention has at least the advantages of reducing the probability of accidental shutdown and increasing the operational stability, and therefore it is suitable for application in a variety of mobile communication devices.

Note that the above element parameters are not limitations of the invention. A designer can adjust these settings according to different requirements. The mobile device and control method of the invention are not limited to the configurations of FIGS. 1-6. The invention may merely include any one or more features of any one or more embodiments of FIGS. 1-6. In other words, not all of the features displayed in the figures should be implemented in the mobile device and control method of the invention.

The method of the invention, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered exemplary only, with the true scope of the disclosed embodiments being indicated by the following claims and their equivalents.

What is claimed is:

1. A mobile device for avoiding accidental shutdown, selectively coupled to a power supply device, and comprising:
a battery cell;
a controller, defining a first delay time and a second delay time, wherein the first delay time is relative to ODCP (Over Discharge Current Protection) of the battery cell, and the second delay time is relative to OVP (Over Voltage Protection) of the battery cell; and
a jack element, comprising a detection pin, wherein when a plug of the power supply device is unplugged from the jack element, the detection pin notifies the controller, such that the controller detects an SOH (State of Health) of the battery cell;
wherein if the SOH is better than a first threshold ratio, the controller extends the first delay time and the second delay time according to a first multiplier;
wherein if the SOH is between the first threshold ratio and a second threshold ratio, the controller extends the first delay time and the second delay time according to a second multiplier;
wherein if the SOH is worse than the second threshold ratio, the controller extends the first delay time and the second delay time according to a third multiplier.

2. The mobile device as claimed in claim 1, wherein the controller is implemented with a gauge IC (Integrated Circuit), an EC (Embedded Controller), or a combination thereof.

3. The mobile device as claimed in claim 1, wherein in response to extension of the first delay time and the second delay time, the controller starts to count a predetermined time.

4. The mobile device as claimed in claim 3, wherein after the predetermined time expires, the controller restores the first delay time and the second delay time to unextended states.

5. The mobile device as claimed in claim 1, wherein the first threshold ratio is equal to 70%.

6. The mobile device as claimed in claim 1, wherein the second threshold ratio is equal to 30%.

7. The mobile device as claimed in claim 1, wherein the first multiplier is equal to 2.

8. The mobile device as claimed in claim 1, wherein the second multiplier is equal to 3.

9. The mobile device as claimed in claim 1, wherein the third multiplier is equal to 4.

10. A control method for avoiding accidental shutdown, comprising the steps of:
providing a battery cell, a controller, and a jack element;
defining a first delay time and a second delay time via the controller, wherein the first delay time is relative to ODCP (Over Discharge Current Protection) of the battery cell, and the second delay time is relative to OVP (Over Voltage Protection) of the battery cell;
when a plug of the power supply device is unplugged from the jack element, detecting an SOH (State of Health) of the battery cell via the controller;
if the SOH is better than a first threshold ratio, extending the first delay time and the second delay time via the controller according to a first multiplier;
if the SOH is between the first threshold ratio and a second threshold ratio, extending the first delay time and the second delay time via the controller according to a second multiplier; and
if the SOH is worse than the second threshold ratio, extending the first delay time and the second delay time via the controller according to a third multiplier.

11. The control method as claimed in claim 10, wherein the first threshold ratio is equal to 70%.

12. The control method as claimed in claim 10, wherein the second threshold ratio is equal to 30%.

13. The control method as claimed in claim 10, wherein the first multiplier is equal to 2.

14. The control method as claimed in claim 10, wherein the second multiplier is equal to 3.

15. The control method as claimed in claim 10, wherein the third multiplier is equal to 4.
